(19) United States
(12) Patent Application Publication
(10) Pub. No.: US 2025/0256497 A1
(43) Pub. Date: Aug. 14, 2025

(54) SUPPORT COMPONENT AND LAMINATION DEVICE

(71) Applicant: Yungu (Gu’an) Technology Co., Ltd., Langfang (CN)

(72) Inventors: Zeming YANG, Langfang (CN); Zhipeng XU, Langfang (CN); Yuanyuan CHEN, Langfang (CN); Liubin FAN, Langfang (CN); Mingxing LIU, Langfang (CN); Jingjing ZHAO, Langfang (CN)

(73) Assignee: Yungu (Gu’an) Technology Co., Ltd., Langfang (CN)

(21) Appl. No.: 19/193,916

(22) Filed: Apr. 29, 2025

Related U.S. Application Data
(63) Continuation of application No. PCT/CN2023/090839, filed on Apr. 26, 2023.

(30) Foreign Application Priority Data
Nov. 24, 2022 (CN) 202211484296.X

(51) Int. Cl. B32B 37/00; B32B 37/10

(52) U.S. Cl. CPC B32B 37/0046; B32B 37/10; B32B 2457/20

(57) ABSTRACT

The embodiments of the present application provide a support component and a lamination device. The support component is configured to laminate a curved cover plate with a flexible screen, and the support component includes: a base having a support surface on one side in a first direction; and a flexible support table arranged on the support surface and configured to support the flexible screen, the flexible support table including a body, a strip-shaped portion connected to the body, and an edge portion arranged on a side of the strip-shaped portion facing away from the body, at least part of the strip-shaped portion being spaced apart from the base, and the edge portion abutting against the support surface.

### CROSS-REFERENCE TO RELATED APPLICATIONS

The present application a continuation of International Application No. PCT/CN2023/090839 filed on Apr. 26, 2023, which claims priority to Chinese Patent Application No. 202211484296.X, filed on Nov. 24, 2022. All of the aforementioned patent applications are hereby incorporated by reference in their entireties.

### FIELD

The present application relates to the field of flexible screen lamination equipment, and in particular to a support component and a lamination device.

### BACKGROUND

With the advent of the ubiquitous screen era, people's demand for full screens is becoming stronger and stronger. In order to increase the screen-to-body ratio, dual-curved lamination technology and quad-curved lamination technology have emerged.

In the prior art, the flexible characteristics of the flexible screen are mainly used to achieve a full screen. At present, the lamination methods for the flexible screen are mainly to use a silicone pad to press the flexible screen to an inner side of a glass curved cover plate. During lamination, the silicone pad is deformed due to the pressures from upper and lower jigs, to complete the lamination of the flexible screen with the curved cover plate. When the silicone pad is not deformed enough, it is possible to cause bubbles between the flexible screen and the curved cover plate.

### SUMMARY

Embodiments of the present application provide a support component and a lamination device, which are intended to solve the problem of the generation of bubbles during lamination of a flexible screen with a curved cover plate.

In an aspect, the embodiments of the present application provide a support component for laminating a curved cover plate with a flexible screen, the support component including: a base having a support surface on one side in a first direction; and a flexible support table arranged on the support surface and configured to support the flexible screen, the flexible support table including a body, a strip-shaped portion connected to the body, and an edge portion arranged on a side of the strip-shaped portion facing away from the body, at least part of the strip-shaped portion being spaced apart from the base, and the edge portion abutting against the support surface.

In a second aspect, the embodiments of the present application further provide a lamination device for laminating a curved cover plate with a flexible screen, the lamination device including a support component according to any of the above embodiments of the first aspect, and a pressing table, the pressing table being arranged on one side of the support component, the pressing table having a receiving recess for receiving the curved cover plate, and an opening of the receiving recess facing the support component.

The support component provided in the embodiments of the present application is configured to support the flexible screen during the lamination of the curved cover plate with the flexible screen. The support component includes a base and a flexible support table. A support surface of the base is configured to provide support to the flexible support table. The flexible support table includes a body, a strip-shaped portion and an edge portion. At least part of the strip-shaped portion is spaced apart from the base, and the edge portion abuts against the support surface of the base. During the lamination of the curved cover plate with the flexible screen, when the curved cover plate exerts a force toward the strip-shaped portion, at least part of the strip-shaped portion will be recessed and deformed toward the support surface due to a large gap between the at least part of the strip-shaped portion and the support surface, the edge portion is warped and deformed away from the support surface under this effect, so that the flexible screen and a specially-shaped portion of the curved cover plate are laminated more tightly, and the problem of the presence of lamination bubbles between the specially-shaped portion of the curved cover plate and the flexible screen can be effectively solved.

### BRIEF DESCRIPTION OF THE DRAWINGS

FIG. 1 is a structural schematic view of a curved cover plate and a flexible screen according to an embodiment of the present application;

FIG. 2 is a structural schematic perspective view of a support component according to an embodiment of the present application;

FIG. 3 is a front view of a support component according to an embodiment of the present application;

FIG. 4 is a top view of a support component according to an embodiment of a first aspect of the present application;

FIG. 5 is a cross-sectional view along line A-A in FIG. 4;

FIG. 6 is a structural schematic view of a base of a support component according to an embodiment of the present application;

FIG. 7 is a partial cross-sectional view of a base of a support component according to an embodiment of the present application;

FIG. 8 is a structural schematic partial enlarged view of FIG. 7 in an example;

FIG. 9 is a structural schematic partial enlarged view of FIG. 7 in another example;

FIG. 10 is a structural schematic partial enlarged view of FIG. 7 in still another example;

FIG. 11 is a structural schematic partial enlarged view of FIG. 5;

FIG. 12 is a structural schematic view of a base of a support component according to another embodiment of the present application; and

FIG. 13 is a structural schematic view of a lamination device according to an embodiment of the present application.

### DETAILED DESCRIPTION OF THE EMBODIMENTS

As shown in FIG. 1, FIG. 1 shows a structural schematic exploded view of a display device including a flexible screen 20 and a curved cover plate 10 which are laminated with each other. The curved cover plate 10 includes a flattened portion 12 and a specially-shaped portion 11 located on at least one side in a circumferential direction of the flattened portion 12. The specially-shaped portion 11 is bent with respect to the flattened portion 12, and the flexible screen 20 is laminated with the flattened portion 12 and the specially-shaped portion 11 so that the specially-shaped portion 11 is also available for display, thereby increasing the screen-to-body ratio of the display device.

During the lamination of the flexible screen 20 with the curved cover plate 10, the flexible screen 20 is generally arranged on a deformable flexible support table 200, such that the flexible screen 20 can be better laminated with the specially-shaped portion 11 of the curved cover plate 10 by means of the deformation of the flexible support table 200. In the prior art, since the shape of the specially-shaped portion 11 is irregular, the specially-shaped portion 11 has a specially-shaped curved surface, resulting in lamination bubbles between the specially-shaped portion 11 and the flexible screen 20.

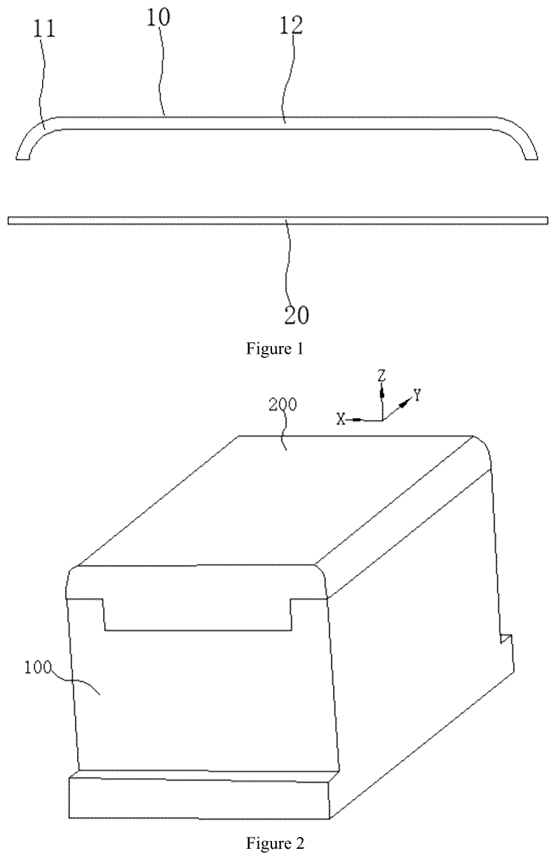

In order to solve the above problem, the present application is provided. In order to better understand the present application, a support component and a lamination device according to the embodiments of the present application will be described in detail below with reference to FIGS. 2 to 12.

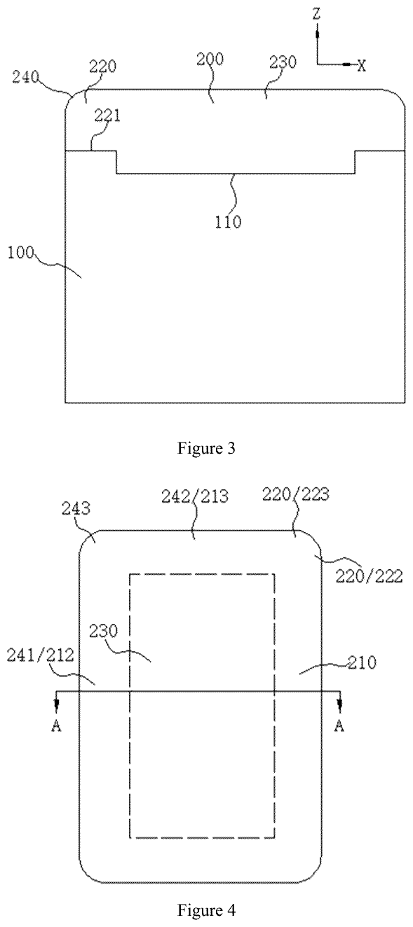

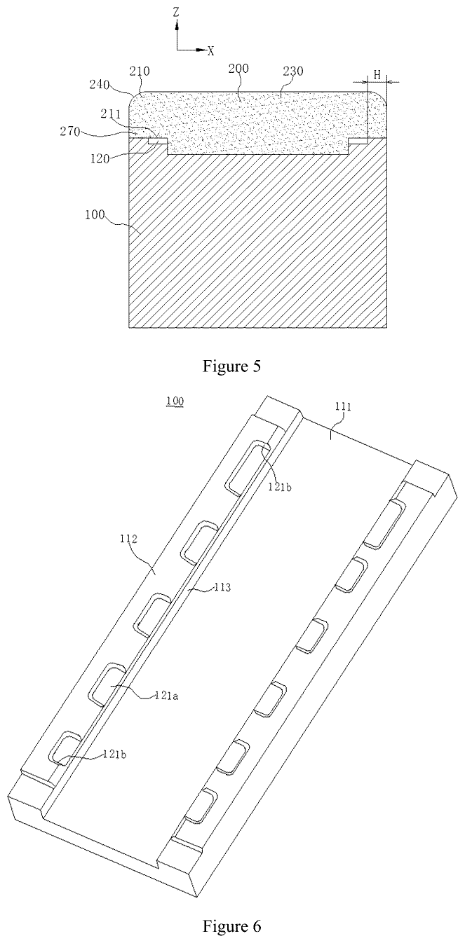

Referring to FIGS. 2 to 5 together, FIG. 2 is a structural schematic perspective view of a support component according to an embodiment of a first aspect of the present application, FIG. 3 is a front view of a support component according to an embodiment of the first aspect of the present application, and FIG. 4 is a top view of a support component according to an embodiment of the first aspect of the present application. FIG. 5 is a cross-sectional view along line A-A in FIG. 4.

As shown in FIGS. 2 to 5, the embodiments of the first aspect of the present application provide a support component for laminating a curved cover plate 10 with a flexible screen 20 as shown in FIG. 1. The support component includes a base 100 and a flexible support table 200. The base 100 has a support surface 110 on one side in a first direction Z. The flexible support table 200 is arranged on the support surface 110 and configured to support the flexible screen 20. The flexible support table 200 includes a body 230, a strip-shaped portion 210 connected to the body 230, and an edge portion 270 arranged on a side of the strip-shaped portion 210 facing away from the body, at least part of the strip-shaped portion 210 is spaced apart from the base 100, and the edge portion 270 abuts against the support surface 110.

By at least part of the strip-shaped portion 210 being spaced apart from the base 100, for example, the strip-shaped portion 210 includes a first surface 211 facing the support surface 110, and the first surface 211 is spaced apart from the support surface 110. The edge portion 270 includes a second surface 221 facing the support surface 110. The second surface 221 and the support surface 110 abut against each other.

The base 100 may be configured in a variety of ways. In one embodiment, the base 100 may be formed from a rigid material such as metal and plastic, such that the base 100 can provide good support for the flexible support table 200.

The flexible support table 200 may be configured in a variety of ways. In one embodiment, the flexible support table 200 may be formed from a flexible material such as silicone, such that the flexible support table 200 has a good deformation capability. The flexible support table 200 may alternatively be formed from another elastic material with deformation capability, as long as the flexible support table 200 has a certain flexibility, and the surface of the flexible support table 200 for supporting the flexible screen 20 can be deformed.

The strip-shaped portion 210 and the bent portion 220 may be configured in a variety of ways. For example, the strip-shaped portion 210 is arranged on one side of the body 230 and extends in the form of a strip in a certain direction, and a plurality of strip-shaped portions 210 enclose the body 230 in different directions.

In one embodiment, the surface of the flexible support table 200 for supporting the flexible screen 20 is adapted to the shape of the curved cover plate 10.

The support component provided in the embodiments of the present application is configured to support the flexible screen 20 during the lamination of the curved cover plate 10 with the flexible screen 20. The support component includes a base 100 and a flexible support table 200. A support surface 110 of the base 100 is configured to provide support to the flexible support table 200. The flexible support table 200 includes a body 230, a strip-shaped portion 210 and an edge portion 270. At least part of the strip-shaped portion 210 is spaced apart from the base 100, and the edge portion 270 abuts against the support surface 110 of the base 100. During the lamination of the curved cover plate 10 with the flexible screen 20, when the curved cover plate 10 exerts a force toward the strip-shaped portion 210, at least part of the strip-shaped portion 210 will be recessed and deformed toward the support surface 110 due to a large gap between the at least part of the strip-shaped portion 210 and the support surface 110, and the edge portion 270 is warped and deformed away from the support surface 110 under this effect, so that the flexible screen 20 and a specially-shaped portion 11 of the curved cover plate 10 are laminated more tightly, and the problem of the presence of lamination bubbles between the specially-shaped portion 11 and the flexible screen 20 can be effectively solved.

There are various ways in which the strip-shaped portion 210 is spaced apart from the support surface 110. For example, a blind recess may be provided in the strip-shaped portion 210. The blind recess is formed by recessing in a direction away from the support surface 110 to increase the distance between a bottom wall surface of the blind recess and the support surface 110, and the distance between the strip-shaped portion 210 and the support surface 110 is thus increased so that the strip-shaped portion 210 is spaced apart from the base 100.

Referring to FIGS. 2 to 6 together, FIG. 6 is a structural schematic view of a base 100 of a support component according to an embodiment of the present application.

In some other embodiments, as shown in FIGS. 2 to 6, the support surface 110 is provided with a recess 120. An orthographic projection of the recess 120 in the first direction Z at least partially overlaps an orthographic projection of the strip-shaped portion 210 in the first direction Z. The strip-shaped portion 210 is spaced apart from a bottom wall surface of the recess 120.

In these embodiments, by providing a recess 120 on the support surface 110, and by making the orthographic projections of the recess 120 and the strip-shaped portion 210 at least partially overlap each other, at least part of the strip-shaped portion 210 is spaced apart from the bottom wall surface of the recess 120, and there is a gap between the at least part of the strip-shaped portion 210 and the bottom wall surface of the recess 120. During the lamination of the curved cover plate 10 with the flexible screen 20, at least part of the strip-shaped portion 210 can be recessed and deformed in the direction of the bottom wall surface of the recess 120 under the force of the curved cover plate 10, and the edge portion 270 is warped toward the curved cover plate 10 under this effect, to increase the laminating force between the specially-shaped portion 11 and the flexible screen 20, thereby reducing lamination bubbles between the specially-shaped portion 11 and the flexible screen 20.

In one embodiment, the strip-shaped portion 210 includes a first strip-shaped portion 212 located on at least one side of the body 230 in a second direction X, a second strip-shaped portion 213 located on at least one side of the body 230 in a third direction Y, and a bent portion 220 connecting the first strip-shaped portion 212 and the second strip-shaped portion 212. The orthographic projection of the recess 120 in the first direction Z at least partially overlaps an orthographic projection of the first strip-shaped portion 212 and/or the second strip-shaped portion 213 in the first direction Z.

The recess 120 may be configured in a variety of ways. In one embodiment, the recess 120 may be integrally formed, and the recess 120 may be arranged corresponding to the first strip-shaped portion 212 and/or the second strip-shaped portion 213 on a one-to-one basis. Alternatively, as shown in FIG. 6, the recess 120 includes a plurality of sub-recesses. The plurality of sub-recesses are spaced apart from each other in the third direction Y, and are arranged corresponding to the same first strip-shaped portion 212 and/or second strip-shaped portion 213.

During the lamination of the curved cover plate 10 with the flexible screen 20, the middle of the first strip-shaped portion 212 and/or the second strip-shaped portion 213 may be deformed toward the bottom wall surface of the recess 120 under the force of the curved cover plate 10, and parts of the first strip-shaped portion 212 and/or the second strip-shaped portion 213 and the bent portion 220 may be warped toward the curved cover plate 10 in a direction from the middle of the first strip-shaped portion 212 and/or the second strip-shaped portion 213 to the bent portion 220, to increase the warpage height of the bent portion 220. In some other embodiments, it is also possible that the first strip-shaped portion 212 and/or the second strip-shaped portion 213 is deformed as a whole toward a bottom wall of the recess 120, while the bent portion 220 is warped and deformed toward the curved cover plate 10. In the embodiments of the present application, the provision of the recess 120 in the base 100 instead of the flexible support table 200 can ensure that the flexible support table 200 has a sufficient thickness and thus has a sufficient deformation capability, thereby better alleviating the problem of lamination bubbles being likely to be generated between the curved cover plate 10 and the flexible screen 20.

In one embodiment, the edge portion 270 and the support surface 110 are laminated with each other, so that the support surface 110 can provide better support to the flexible support table 200.

In one embodiment, the surface of the edge portion 270 facing the base 100 is coplanar with the surface of the strip-shaped portion 210 facing the base 100, that is, the first surface 211 is coplanar with the second surface 221, so that the structure of the flexible support table 200 can be simplified, and the preparation and formation of the flexible support table 200 can be facilitated. In addition, the thickness variation of the flexible support table 200 can be made more uniform, and the force exerted by the flexible support table 200 on the flexible screen 20 can be more balanced without sudden changes, thereby alleviating the problem of the curved cover plate 10 being prone to crack during the lamination.

In one embodiment, the recess 120 has a depth greater than or equal to 1 mm to alleviate the problem of too small deformation distance of the strip-shaped portion 210 toward the recess 120 caused by the insufficient depth of the recess 120, which results in that the bent portion 220 or at least the rest of the strip-shaped portion 210 is warped toward the curved cover plate 10 by a small distance and the problem of lamination bubbles generated between the curved cover plate 10 and the flexible screen 20 thus cannot be properly alleviated. The depth of the recess 120 is the extension depth of the recess 120 in the first direction Z.

In one embodiment, a distance H between the recess 120 and an outer edge of the support surface 110 may be equal to 0, to increase the distribution area of the recess 120 and improve the deformation capability of the strip-shaped portion 210.

In one embodiment, the distance H between the recess 120 and the outer edge of the support surface 110 is greater than or equal to 1.5 mm, such that the distance between the recess 120 and the support surface 110 is large enough, and the problem of non-tight lamination between the edge of the curved cover plate 10 and the flexible screen 20 due to the too small distance between the recess 120 and the edge of the support surface 110 can be thus alleviated. In some embodiments, still referring to FIG. 2, the surface of the body 230 for supporting the flexible screen 20 is planar and the surface of the strip-shaped portion 210 for supporting the flexible screen 20 is curved, and the strip-shaped portion 210 includes a first strip-shaped portion 212 located on at least one side of the body 230 in the second direction X, but does not include a second strip-shaped portion 212.

In these embodiments, the curved cover plate 10 is a dual-curved or single-curved cover plate. The recess 120 may then be configured to traverse in the third direction to better alleviate the problem of the presence of lamination bubbles between the flexible screen 20 supported by the first strip-shaped portion 212 and the curved cover plate 10.

In some other embodiments, as described above, the strip-shaped portion 210 includes a first strip-shaped portion 212, a second strip-shaped portion 213, and a bent portion 220. Surfaces of the first strip-shaped portion 212, the second strip-shaped portion 213 and the bent portion 220 for supporting the flexible screen 20 are all curved. For example, the flexible support table 200 includes an arc-shaped region 240. The first strip-shaped portion 212, the second strip-shaped portion 213 and the bent portion 220 are arranged in the arc-shaped region 240.

In one embodiment, when the surfaces of the first strip-shaped portion 212 and the second strip-shaped portion 213 for supporting the flexible screen 20 are both curved, the orthographic projection of the recess 120 in the first direction Z and the orthographic projection of the bent portion 220 in the first direction Z are misaligned with each other.

In these embodiments, the flexible screen 20 supported by the bent portion 220 and the curved cover plate 10 are more prone to the generation of lamination bubbles as compared to the first strip-shaped portion 212 and the second strip-shaped portion 213. By the orthographic projection of the recess 120 in the first direction Z and the orthographic projection of the bent portion 220 in the first direction Z being misaligned with each other, it is meant that the support surface 110 is flatter and the flexible support table 200 is more tightly laminated with the support surface 110 at a position where the bent portion 220 is located, so that the bent portion 220 can provide better support to the flexible screen 20, and the problem of lamination bubbles between the flexible screen 20 supported by the bent portion 220 and the curved cover plate 10 can be better alleviated.

In an embodiment of the present application, the recess 120 corresponds to the strip-shaped portion 210 and the bent portion 220 of the arc-shaped region 240 rather than to the body 230, enabling an increase in the support force provided by the support surface 110 to the body 230 of the flexible support table 200, thereby reducing the influence of the recess 120 on the mutual lamination between the flexible screen 20 supported by the body 230 and the curved cover plate 10.

The curved cover plate 10 may be configured in a variety of ways. It is possible that the curved cover plate 10 is a dual-curved cover plate, and the curved cover plate 10 includes two specially-shaped portions 11 on two sides of the flattened portion 12 in the second direction X. Alternatively, the curved cover plate 10 is a quad-curved cover plate, and the curved cover plate 10 includes four specially-shaped portions 11 located on the peripheral side of the flattened portion 12 and bent portions for connecting every two adjacent specially-shaped portions 11.

Correspondingly, the arc-shaped region 240 is configured in a variety of ways. When the curved cover plate 10 is a dual-curved cover plate, the arc-shaped region 240 includes a first arc-shaped region 241 located on at least one side of a planar region 230 in the second direction X. The first arc-shaped region 241 extends in the third direction Y. The first strip-shaped portion 212 is located in the first arc-shaped region 241.

In one embodiment, when the curved cover plate 10 is a quad-curved cover plate, the arc-shaped region 240 includes a first arc-shaped region 241 as described above, and a second arc-shaped region 242 located on at least one side of the planar region 230 in the third direction Y. The second arc-shaped region 242 extends in the second direction X. The arc-shaped region 240 may further include a bent region 243 connecting the first arc-shaped region 241 and the second arc-shaped region 242. The first strip-shaped portion 212 is located in the first arc-shaped region 241, the second strip-shaped portion 213 is located in the second arc-shaped region 242, and the bent portion 220 is located in the bent region 243.

Still referring to FIGS. 2 to 6, when the arc-shaped region 240 includes the first arc-shaped region 241 as described above, the strip-shaped portion 210 includes a first strip-shaped portion 212 located in the first arc-shaped region 241. That is, the strip-shaped portion 210 includes a first strip-shaped portion 212 located on at least one side of the body 230 in the second direction X. The bent portion 220 includes a first bent portion 222 located on at least one side of the first strip-shaped portion 212 in the third direction Y, the recess 120 includes a first recess 121, and an orthographic projection of the first recess 121 in the first direction Z is arranged to at least partially overlap an orthographic projection of the first strip-shaped portion 212 in the first direction Z.

In these embodiments, the orthographic projection of the first recess 121 in the first direction Z is arranged to at least partially overlap the orthographic projection of the first strip-shaped portion 212 in the first direction Z, and at least part of the first strip-shaped portion 212 in the first arc-shaped region 241 can be deformed toward a bottom wall of the first recess 121 under the action of the specially-shaped portion 11, so that the first bent portion 222 and at least the rest of the first strip-shaped portion 212 can be warped in the first direction Z along two ends of the specially-shaped portion 11 in the third direction Y, thereby alleviating the problem of lamination bubbles between the two ends of the specially-shaped portion 11 in the third direction Y and the flexible screen 20.

In one embodiment, the first recess 121 and the first strip-shaped portion 212 are both symmetrically arranged with respect to a first reference plane P. The first reference plane P is parallel to a plane in which the first direction Z and the second direction X are located. In one embodiment, the first reference plane P is perpendicular to the third direction Y. In these embodiments, the first recess 121 and the first strip-shaped portion 212 are both symmetrically arranged with respect to the first reference plane P, and when the first strip-shaped portion 212 is deformed toward the bottom wall surface of the first recess 121, the first bent portion 222 is warped toward the specially-shaped portion 11, so that the warpage shapes of the first bent portion 222 on two sides of the third direction Y tend to be consistent, thereby better alleviating the problem of lamination bubbles between the two ends of the specially-shaped portion 11 in the third direction Y and the flexible screen 20.

In one embodiment, the orthographic projection of the first recess 121 in the first direction Z is located within the orthographic projection of the first strip-shaped portion 212 in the first direction Z. In these embodiments, the orthographic projection of the first recess 121 is located within the orthographic projection of the first strip-shaped portion 212, so that the first recess 121 can better alleviate the problem of the presence of lamination bubbles between the flexible screen 20 supported by the first strip-shaped portion 212 and the specially-shaped portion 11. Moreover, the influence of the first recess 121 on the mutual lamination between the flexible screen 20 supported by the body 230 and the curved cover plate 10 can be reduced.

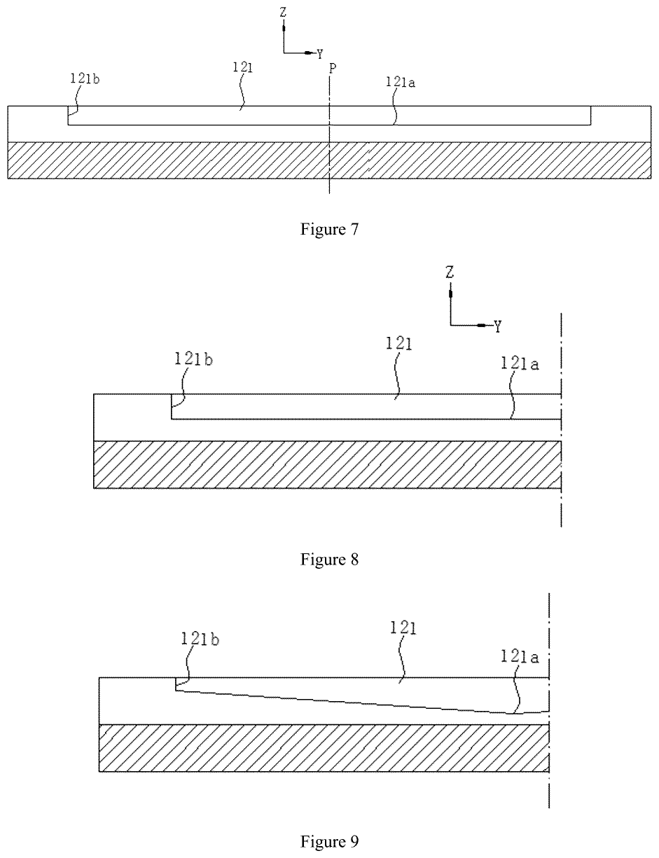

Referring to FIGS. 7 to 8 together, FIG. 7 is a cross-sectional view of a base 100 of a support component according to an embodiment of the present application. FIG. 8 is a structural schematic partial enlarged view of FIG. 7. In the embodiment shown in FIG. 7, the recess 120 is integrally formed, and the recess 120 is arranged corresponding to the first strip-shaped portion 212 and/or the second strip-shaped portion 213 on a one-to-one basis.

In one embodiment, the depth of the first recess 121 is constant in the third direction Y to simplify the shape of the first recess 121 and facilitate the preparation of the base 100.

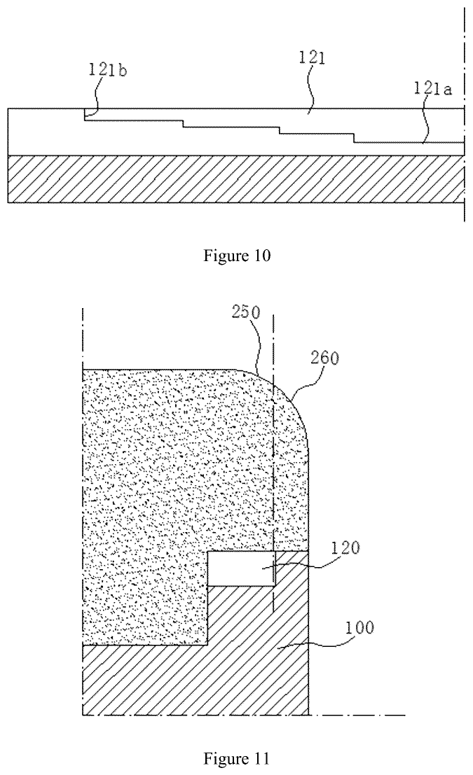

Referring to FIG. 7 and FIGS. 9 to 10 together, FIG. 9 is a structural schematic partial enlarged view of a base of a support component according to another embodiment, and FIG. 10 is a structural schematic partial enlarged view of a base of a support component according to still another embodiment.

In some other embodiments, as shown in FIG. 7 and FIGS. 9 to 10, the depth of the first recess 121 gradually decreases in a direction from the first reference plane to at least one side of the first recess 121 in the third direction Y.

In these embodiments, the first recess 121 has a maximum depth at the position where the first reference plane P is located, and the closer to the bent portion 220, the smaller the depth of the first recess 121. During the lamination of the curved cover plate 10 with the flexible screen 20, the closer to the position where the first reference plane P is located, the greater the deformation capability of the first strip-shaped portion 212, and the closer to the vicinity of the first bent portion 222, the smaller the deformation capability of the first strip-shaped portion 212, so that it is possible to ensure that the first bent portion 222 has a sufficient thickness and deformation capability, and the first bent portion 222 can better support the lamination of the flexible screen 20 with the specially-shaped portion 11.

The depth of the first recess 121 may decrease in a variety of ways. For example, as shown in FIG. 9, the first recess 121 includes a first bottom wall surface 121a and first side wall surfaces connected to the first bottom wall surface 121a and located on two sides of the third direction Y. The first bottom wall surface 121a includes two first inclined surfaces connected to each other. The connection between the first inclined surfaces is located at the position where the first reference plane P is located. The first inclined surfaces are planar, and are inclined in a direction close to the flexible support table 200 from the position where the first reference plane P is located to the first side wall surfaces, so that the depth of the first recess 121 gradually decreases in the direction from the first reference plane P to at least one side of the first recess 121 in the third direction Y. In some other embodiments, it is also possible that, as shown in FIG. 10, the first bottom wall surface 121a is in the shape of a step.

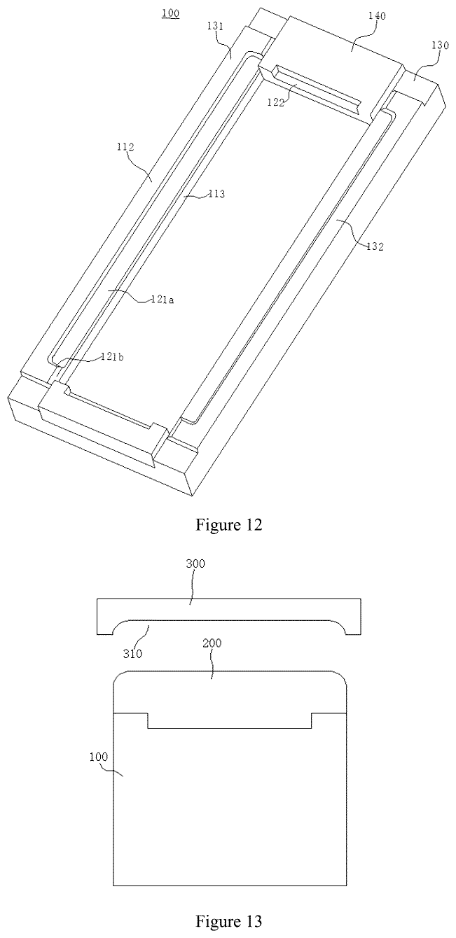

Referring to FIGS. 4 and 12 together, FIG. 12 is a structural schematic view of a base of a support component according to another embodiment of the present application.

In some embodiments, as shown in FIGS. 4 and 12, the arc-shaped region 240 further includes a second arc-shaped region 242 located on at least one side of the body 230 in the third direction Y, and the strip-shaped portion 210 includes a second strip-shaped portion 213 in the second arc-shaped region 242. That is, the strip-shaped portion 210 includes a second strip-shaped portion 213 located on at least one side of the body 230 in the third direction Y. The bent portion 220 includes a second bent portion 223 located on at least one side of the second strip-shaped portion 213 in the second direction X. The recess 120 includes a second recess 122. An orthographic projection of the second recess 122 in the first direction Z is arranged to at least partially overlap an orthographic projection of the second strip-shaped portion 213 in the first direction Z.

In these embodiments, the orthographic projection of the second recess 122 in the first direction Z is arranged to at least partially overlap the orthographic projection of the second strip-shaped portion 213 in the first direction Z, and the second strip-shaped portion 213 in the second arc-shaped region 242 can be deformed toward a bottom wall of the second recess 122 under the action of the specially-shaped portion 11, so that the second bent portion 223 can be warped toward two ends of the specially-shaped portion 11 in the second direction X, thereby alleviating the problem of lamination bubbles between the two ends of the specially-shaped portion 11 in the second direction X and the flexible screen 20.

In one embodiment, the second recess 122 and the second strip-shaped portion 213 are both symmetrically arranged with respect to a second reference plane. The second reference plane is parallel to a plane in which the first direction Z and the third direction Y are located. In one embodiment, the second reference plane is perpendicular to the second direction X. In these embodiments, the second recess 122 and the second strip-shaped portion 213 are both symmetrically arranged with respect to the second reference plane, and when at least part of the second strip-shaped portion 213 is deformed toward the bottom wall surface of the second recess 122, the second bent portion 223 and at least the rest of the second strip-shaped portion 213 are warped toward the specially-shaped portion 11, so that the warpage shapes of the second bent portion 223 on two sides of the second direction X tend to be consistent, thereby better alleviating the problem of lamination bubbles between the two ends of the specially-shaped portion 11 in the second direction X and the flexible screen 20.

In one embodiment, the orthographic projection of the second recess 122 in the first direction Z is located within the orthographic projection of the second strip-shaped portion 213 in the first direction Z. In these embodiments, the orthographic projection of the second recess 122 is located within the orthographic projection of the second strip-shaped portion 213, so that the second recess 122 can better alleviate the problem of the presence of lamination bubbles between the flexible screen 20 supported by the second strip-shaped portion 213 and the specially-shaped portion 11. Moreover, the influence of the second recess 122 on the mutual lamination between the flexible screen 20 supported by the body 230 and the curved cover plate 10 can be reduced.

In one embodiment, the depth of the second recess 122 is constant in the second direction X to simplify the shape of the second recess 122 and facilitate the preparation of the base 100.

In some other embodiments, the depth of the second recess 122 gradually decreases in a direction from the second reference plane to at least one side of the second recess 122 in the second direction X.

In these embodiments, the depth of the second recess 122 is greatest at the position where the second reference plane is located, and the closer to the bent portion 220, the smaller the depth of the second recess 122. During the lamination of the curved cover plate 10 with the flexible screen 20, the closer to the position where the second reference plane is located, the greater the deformation capability of the second strip-shaped portion 213, and the closer to the vicinity of the second bent portion 223, the smaller the deformation capability of the second strip-shaped portion 213, so that it is possible to ensure that the second bent portion 223 has a sufficient thickness and deformation capability, and the second bent portion 223 can better support the lamination of the flexible screen 20 with the specially-shaped portion 11.

The depth of the second recess 122 may decrease in a variety of ways. For example, the second recess 122 includes a second bottom wall surface 121b and second side wall surfaces connected to the second bottom wall surface 121b and located on two sides of the third direction Y. The second bottom wall surface 121b includes two second inclined surfaces connected to each other. The connection between the second inclined surfaces is located at the position where the second reference plane is located. The second inclined surfaces are planar, and are inclined in a direction close to the flexible support table 200 from the second reference plane to the second side wall surfaces, so that the depth of the second recess 122 gradually decreases in the direction from the second reference plane to at least one side of the second recess 122 in the second direction X. In some other embodiments, it is also possible that the second bottom wall surface 121b is in the shape of a step.

In some embodiments, as shown in FIG. 12, the base 100 includes a body portion 130 and a stopper 140. The stopper 140 is configured to support at least part of the second strip-shaped portion 213, and the stopper 140 is provided with the second recess 122. The stopper 140 is relatively small in size to facilitate the manufacturing and formation of the second recess 122.

In one embodiment, the body portion 130 includes a first boss 131 and a second boss 132 for supporting the first strip-shaped portion 212. The first boss 131 and the second boss 132 are spaced apart from each other in the second direction X, and two stoppers 140 are spaced apart from each other in the third direction Y between the first boss 131 and the second boss 132. By adjusting the distance between the two stoppers 140, the base 100 can be adapted to different sizes of flexible support tables 100, so that the adaptability of the base 100 can be improved.

In one embodiment, the second recess 122 is configured to traverse the stopper 140 in the second direction X. For example, when the stopper 140 is used to support the middle of the second strip-shaped portion 213, the second recess 122 traverses the stopper 140 in the second direction X, to improve the deformation capability of the second strip-shaped portion 213.

In some other embodiments, it is also possible that the second recess 122 is configured not to traverse the stopper 140 in the second direction X.

As described above, when the surfaces of the first strip-shaped portion 212 and the second strip-shaped portion 213 for supporting the flexible screen 20 are both curved, the orthographic projection of the recess 120 in the first direction Z and the orthographic projection of the bent portion 220 in the first direction Z are misaligned with each other. The recess 120 includes a first recess 121 in the first arc-shaped region 241 and a second recess 122 in the second arc-shaped region 242, and the bent portion 220 of the flexible support table 200 is warped and deformed when the first strip-shaped portion 212 and the second strip-shaped portion 213 are deformed toward the support surface 110, so that the problem of lamination bubbles between the flexible screen 20 supported by the bent portion 220 and the curved cover plate 10 can be better alleviated.

In one embodiment, the first bent portion 222 and the second bent portion 223 are both located in the bent region 243 to better alleviate the problem of lamination bubbles between the flexible screen 20 supported in the bent region 243 and the curved cover plate 10.

Referring to FIGS. 4 and 11 together, FIG. 11 is a structural schematic partial enlarged view of FIG. 4.

In some embodiments, as shown in FIGS. 4 and 11, a surface of the strip-shaped portion 210 facing away from the base 100 includes a first arc-shaped surface 250 and a second arc-shaped surface 260 arranged side by side in a direction from the body 230 to the strip-shaped portion 210. The first arc-shaped surface 250 has a curvature greater than the curvature of the second arc-shaped surface 260, and a first orthographic projection of the first arc-shaped surface 250 in the first direction Z at least partially overlaps a second orthographic projection of the recess 120 in the first direction Z.

In these embodiments, the first arc-shaped surface 250 has a greater curvature, the first arc-shaped surface 250 has a greater degree of bending, and it is more likely to generate lamination bubbles when the flexible screen 20 supported by the first arc-shaped surface 250 is laminated with the specially-shaped portion 11. By the first orthographic projection of the first arc-shaped surface 250 in the first direction Z at least partially overlapping the second orthographic projection of the recess 120 in the first direction Z, it is meant that the recess 120 is arranged corresponding to the first arc-shaped surface 250, and the recess 120 can reduce the thickness of the flexible support table 200 in a region where the first arc-shaped surface 250 is located. It is possible to improve the bending deformation capability of the flexible support table 200 at this position, thereby better alleviating the problem of lamination bubbles being likely to be generated when the flexible screen 20 supported by the first arc-shaped surface 250 is laminated with the specially-shaped portion 11.

In one embodiment, the first orthographic projection is located within the second orthographic projection so that the entire region where the first arc-shaped surface 250 is located is correspondingly provided with the recess 120, thereby better alleviating the problem of lamination bubbles being likely to be generated when the flexible screen 20 supported by the first arc-shaped surface 250 is laminated with the specially-shaped portion 11.

In one embodiment, in the direction from the body 230 to the strip-shaped portion 210, the width of the first orthographic projection is less than the width of the second orthographic projection. The larger the width of the second orthographic projection, the better the problem of lamination bubbles being likely to be generated when the flexible screen 20 supported by the first arc-shaped surface 250 is laminated with the specially-shaped portion 11 can be alleviated.

In some embodiments, still referring to FIGS. 2 to 6, the thickness of the body 230 of the flexible support table 200 is greater than the thicknesses of the strip-shaped portion 210 and the bent portion 220. The support surface 110 includes a first support surface 111 for supporting the strip-shaped portion 210 and the bent portion 220, a second support surface 112 for supporting the body 230, and a first connecting surface 113 connecting the first support surface 111 and the second support surface 112, and the recess 120 is provided on a side of the second support surface 112 facing the first connecting surface 113.

In these embodiments, the body 230 has a greater thickness, enabling the flattened portion 12 to be better laminated with the flexible screen 20. The recess 120 is arranged on the side of the second support surface 112 close to the first connecting surface 113, so that the distance between the recess 120 and an edge of the second support surface 112 can be increased, thereby alleviating the problem of bubbles being likely to be generated when the edge of the specially-shaped portion 11 away from the flattened portion 12 is not tightly laminated with the flexible screen 20.

In one embodiment, the recess 120 is in communication with the first connecting surface 113 to facilitate the preparation and formation of the recess 120.

In one embodiment, when the recess 120 includes a first recess 121 and/or a second recess 122, the first recess 121 and/or the second recess 122 is in communication with the first connecting surface 113.

Referring to FIG. 13, FIG. 13 is a structural schematic view of a lamination device according to an embodiment of the present application.

As shown in FIG. 13, in a second aspect, the embodiments of the present application further provide a lamination device for laminating a curved cover plate 10 with a flexible screen 20. The lamination device includes a support component according to any of the above embodiments of the first aspect, and a pressing table 300. The pressing table 300 is arranged on one side of the support component, and the pressing table 300 has a receiving recess 310 for receiving the curved cover plate 10. An opening of the receiving recess 310 faces the support component. Since the lamination device according to the embodiments of the present application includes the support component as described above, the lamination device of the embodiments of the present application has the beneficial effects of the support component as described above, which will not be repeated herein.

1. A support component for laminating a curved cover plate with a flexible screen, the support component comprising:
a base having a support surface on one side in a first direction; and
a flexible support table arranged on the support surface and configured to support the flexible screen, the flexible support table comprising a body, a strip-shaped portion connected to the body, and an edge portion arranged on a side of the strip-shaped portion facing away from the body, at least part of the strip-shaped portion being spaced apart from the base, and the edge portion abutting against the support surface.

2. The support component according to claim 1, wherein the support surface is provided with a recess, an orthographic projection of the recess in the first direction at least partially overlapping an orthographic projection of the strip-shaped portion in the first direction, and there is a gap between the strip-shaped portion and a bottom wall surface of the recess.

3. The support component according to claim 2, wherein
the depth of the recess is greater than or equal to 1 mm; and
the distance between the recess and an outer edge of the support surface is greater than or equal to 1.5 mm.

4. The support component according to claim 2, wherein the strip-shaped portion comprises a first strip-shaped portion located on at least one side of the body in a second direction, a second strip-shaped portion located on at least one side of the body in a third direction, and a bent portion connecting the first strip-shaped portion and the second strip-shaped portion, and the orthographic projection of the recess in the first direction and an orthographic projection of the bent portion in the first direction are misaligned with each other.

5. The support component according to claim 4, wherein surfaces of the first strip-shaped portion and the second strip-shaped portion that are configured to support the flexible screen are both curved.

6. The support component according to claim 4, wherein the recess comprises a first recess, an orthographic projection of the first recess in the first direction being located within an orthographic projection of the first strip-shaped portion in the first direction.

7. The support component according to claim 6, wherein the first recess is symmetrically arranged with respect to a first reference plane, the first reference plane being parallel to a plane where the first direction and the second direction are located, and a depth of the first recess gradually decreases in a direction from the first reference plane to at least one side of the first recess in the third direction.

8. The support component according to claim 7, wherein the depth of the first recess gradually decreases in directions from the first reference plane to two sides of the first recess in the third direction.

9. The support component according to claim 7, wherein the first strip-shaped portion is symmetrically arranged with respect to the first reference plane.

10. The support component according to claim 6, wherein the recess comprises a second recess, an orthographic projection of the second recess in the first direction being arranged to at least partially overlap an orthographic projection of the second strip-shaped portion in the first direction.

11. The support component according to claim 10, wherein the second recess is symmetrically arranged with respect to a second reference plane, the second reference plane being parallel to a plane where the first direction and the third direction are located, and a depth of the second recess gradually decreases in a direction from the second reference plane to at least one side of the second recess in the second direction.

12. The support component according to claim 10, wherein the second strip-shaped portion is symmetrically arranged with respect to the second reference plane;
and an orthographic projection of the second recess in the first direction is located within the orthographic projection of the second strip-shaped portion in the first direction.

13. The support component according to claim 10, wherein the base comprises a body portion and a stopper arranged at the body portion, the stopper being configured to support at least part of the second strip-shaped portion, and the stopper being provided with the second recess.

14. The support component according to claim 13, wherein the body portion comprises a first boss and a second boss for supporting the first strip-shaped portion, the first boss and the second boss being spaced apart from each other in the second direction, and two stoppers are spaced apart from each other in the third direction between the first boss and the second boss.

15. The support component according to claim 13, wherein the second recess is configured to traverse the stopper in the second direction.

16. The support component according to claim 2, wherein a surface of the strip-shaped portion facing away from the base comprises a first arc-shaped surface and a second arc-shaped surface arranged side by side in a direction from the body to the strip-shaped portion, a curvature of the first arc-shaped surface is greater than the curvature of the second arc-shaped surface, and a first orthographic projection of the first arc-shaped surface in the first direction at least partially overlapping a second orthographic projection of the recess in the first direction.

17. The support component according to claim 16, wherein the first orthographic projection is located within the second orthographic projection;
and in the direction from the body to the strip-shaped portion, a width of the first orthographic projection is less than a width of the second orthographic projection.

18. The support component according to claim 2, wherein
a thickness of the body is greater than a thickness of the strip-shaped portion; and
the support surface comprises a first support surface for supporting the strip-shaped portion, a second support surface for supporting the body, and a first connecting surface connecting the first support surface and the second support surface, and the recess is provided on a side of the second support surface facing the first connecting surface.

19. The support component according to claim 18, wherein the recess is in communication with the first connecting surface.

20. A lamination device for laminating a curved cover plate with a flexible screen, the lamination device comprising:
a support component of claim 1, and
a pressing table arranged on one side of the support component, the pressing table comprising a receiving recess for receiving the curved cover plate, and an opening of the receiving recess facing the support component.
